(19) United States
(12) Patent Application Publication
(10) Pub. No.: US 2026/0119509 A1
(43) Pub. Date: Apr. 30, 2026

(54) LARGE LANGUAGE MODEL-BASED SYSTEM FOR REPLICATING FORMATTED FINANCIAL DOCUMENT

(71) Applicant: Auquan Ltd, London (GB)

(72) Inventors: Chandini Jain, New York, NY (US); Shubham Jain, Bengaluru (IN)

(21) Appl. No.: 19/363,287

(22) Filed: Oct. 20, 2025

Related U.S. Application Data
(60) Provisional application No. 63/711,327, filed on Oct. 24, 2024.

(51) Int. Cl. G06F 16/2457; G06Q 50/18

(52) U.S. Cl. CPC G06F 16/24575; G06Q 50/18

(57) ABSTRACT

Embodiments of the present invention provide a system and method for generating custom financial reports using a generative language model (e.g., a Large Language Model, or LLM). The system allows users to input example reports and specify a task, which the LLM analyzes to understand the structure and content. Based on this analysis, the system generates custom queries to collect relevant data. The collected data is synthesized to form a draft report, which is iteratively refined by comparing it to the example reports. This process ensures the final custom report closely emulates the provided examples in both format and content. The system automates the generation of tailored financial reports, enhancing efficiency and accuracy in financial analysis and reporting.

### RELATED APPLICATIONS

This application claims the benefit of priority under 35 U.S.C. § 119(e) to U.S. Provisional Patent Application No. 63/711,327, titled “Large Language Model-Based System for Replicating Formatted Financial Document Content,” filed October 24, 2024, which is hereby incorporated by reference in its entirety.

### TECHNICAL FIELD

The subject matter of the present disclosure pertains to the field of artificial intelligence (AI), with a specific focus on financial technology and automated document processing. More precisely, it relates to systems and methods that utilize generative language models (e.g., Large Language Models (LLMs)) for the automated processing and generation of structured financial reports. The disclosed techniques employ advanced natural language processing (NLP), machine learning, and document format recognition to autonomously interpret, replicate, and generate financial documents. These documents maintain the specific formatting, content structure, and subject matter of a set of example financial reports. The system is adept at comprehending both the layout and the substantive content of various financial documents provided as example inputs, enabling it to produce equivalent reports that adhere to these established formats and contents automatically. This automation eliminates the need for manual intervention in designating or providing specific instructions for content selection, presentation, and formatting, thereby streamlining the generation of custom reports and enhancing consistency and accuracy in financial reporting and analysis.

### BACKGROUND

In the finance and investment industry, the generation of reports is a critical and frequent activity, with a vast number of reports produced daily to support decision-making processes. These reports, whether they are for regulatory compliance, investment analysis, or portfolio management, often share similarities in content and format across different report types and different entities (e.g., firms). For instance, quarterly earnings reports from various companies typically follow a standard structure, presenting financial statements, management discussion and analysis, and market performance in a consistent format. This uniformity helps in ensuring that stakeholders can easily compare and analyze data across different entities.

Traditionally, the creation of these reports has been a labor-intensive process. Report authors are required to manually gather and select appropriate content for each section of the report, ensuring that all relevant information is included and accurately presented. Once the content is assembled, the report must be formatted according to specific desires and in some cases, standards, which can vary depending on the intended audience or regulatory requirements. While some organizations use report templates to aid in this process, these templates often provide a rigid structure that lacks flexibility. They define the formatting and general layout of the report but do not automate the selection and integration of new, relevant data into the report. Both manual and template-based methods are time-consuming and can be prone to errors, particularly when dealing with large volumes of data or complex reporting requirements. These traditional approaches to report generation do not scale efficiently and can become a bottleneck in fast-paced financial environments where timely and accurate information is crucial.

### BRIEF DESCRIPTION OF THE DRAWINGS

Embodiments of the present invention are illustrated by way of example and not limitation in the figures of the accompanying drawings, in which:

FIG. 1 is a diagram illustrating an example financial report.

FIG. 2 is a diagram illustrating an example of an AI-driven, task-based, data retrieval and processing system, for generating customized output (e.g., custom reports), based on a “learned” workflow that aims to replicate a set of example reports that are provided as input, consistent with some examples.

FIG. 3 is a diagram illustrating an example of a user interface for the system shown in FIG. 2, allowing for an end-user to specify or provide example reports, as input, in order to generate a custom workflow with custom queries and to generate a custom report that replicates the example reports, consistent with some examples.

FIG. 4 is a diagram illustrating an example of the data processing steps that occur as part of a process to generate a custom report, according to some examples.

FIG. 5 is a flow diagram illustrating a method for generating a custom financial report, which emulates or replicates a set of example reports, consistent with some examples.

FIG. 6 is a block diagram illustrating a software architecture, which can be installed on any of a variety of computing devices to perform methods consistent with those described herein.

FIG. 7 illustrates a diagrammatic representation of a machine in the form of a computer system (e.g., a server computer) within which a set of instructions may be executed for causing the machine to perform any one or more of the methodologies discussed herein, according to an example embodiment.

### DETAILED DESCRIPTION

Described herein are techniques for generating an output (e.g., a financial report) using a task-based workflow system that involves the processing of example reports by a generative language model (e.g., an LLM). Specifically, embodiments of the invention include methods and systems for providing a set of example reports as input to the system. These example reports are then analyzed by the LLM in accordance with instructions included through a series of prompts. The initial prompt may instruct the LLM to analyze the reports to break down the subject matter and understand the format of the reports, and to create questions or queries that can be used to select the very content expressed in the example reports. Based on the output of the LLM in response to this first prompt, a series of custom queries, derived based on the output of the LLM, may be executed against a variety of data sources. These custom queries are used to select relevant content, from which the custom report will be generated. This description sets forth numerous specific details and innovative features to provide a comprehensive understanding of the embodiments of the present invention. It will be apparent to those skilled in the art that the present invention may be practiced and implemented in various forms and that the invention can be adapted and modified without departing from its scope as outlined in the following detailed description.

Current solutions for data retrieval and processing in the financial sector often involve manual efforts or semi-automated systems that lack the sophistication to handle complex, multi-faceted tasks efficiently. These systems typically rely on static queries and predefined workflows, which can be inflexible and unable to adapt to the dynamic nature of financial data. Additionally, existing systems may not effectively filter out irrelevant information, leading to noise and inefficiencies in the data processing pipeline. The lack of customization in report generation further limits the utility of these systems, as they may not align with the specific requirements and preferences of different users or organizations.

Moreover, it can be both time-consuming and labor-intensive to obtain and manually synthesize information, as the required data is distributed amongst a variety of different data sources, each having its own unique challenges to obtain. For instance, financial data may be spread across stock exchanges, financial news outlets, company reports, economic indicators, court rulings, and regulatory updates. Each of these sources often requires separate tools, interfaces, and authentication information, adding layers of complexity to the data retrieval process. Analysts must navigate through these disparate systems, manually extract relevant data, and then synthesize it into a coherent format. This fragmented approach not only increases the time and effort required but also heightens the risk of missing critical information or introducing errors. Consequently, the need for specialized analysts who focus on specific types of data or reports further escalates operational costs, making the entire process less efficient and more resource-intensive.

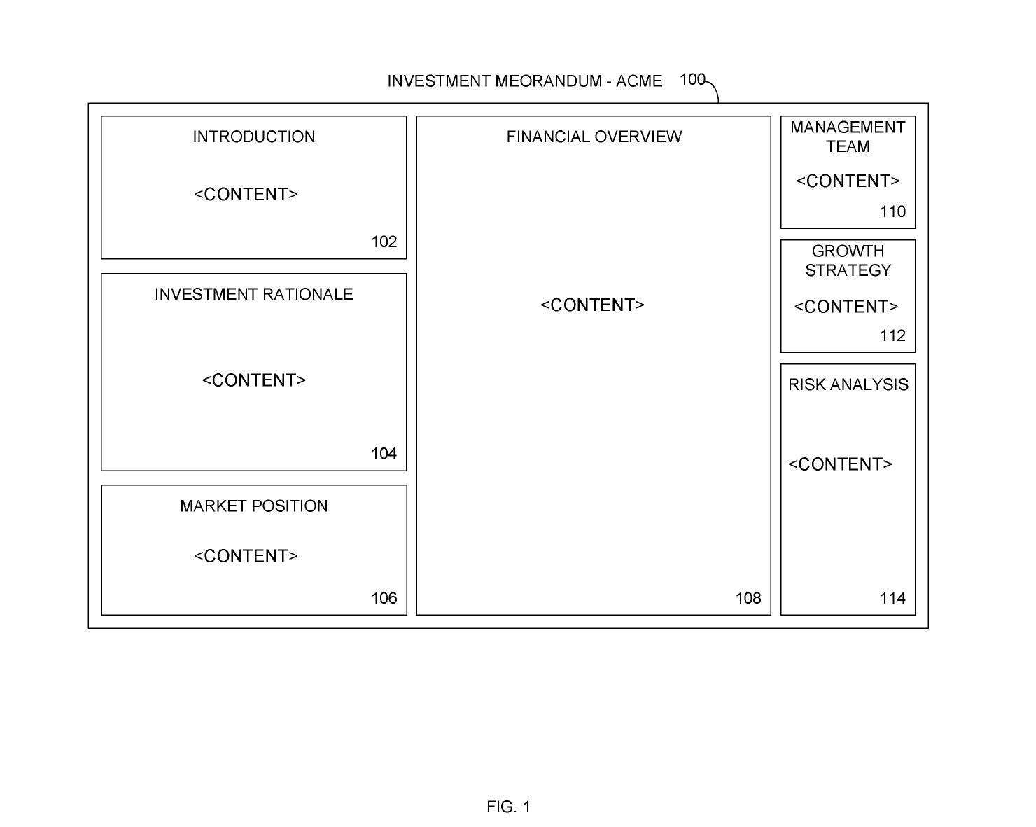

FIG. 1 shows an example of an investment memorandum report 100, illustrating the structured format and various sections that comprise a typical report. This report 100 is designed to convey comprehensive financial information about a company, in this case, ACME. The report includes multiple sections, each dedicated to a specific aspect of the company’s financial and strategic profile. As will be appreciated by those skilled in the art, generating a report 100 as shown in FIG. 1 typically requires a number of steps that are repeated for each individual section of the report, generally including data or information acquisition, information synthesis, and formatting.

Referring now to the report 100 of FIG. 1, the introduction section 102 provides an overview of the report’s purpose and scope. This section typically includes a brief summary of the company’s background, the objectives of the report, and any pertinent context that sets the stage for the detailed analysis that follows.

The investment rationale section 104 outlines the reasons behind the investment decision. This section includes an analysis of the company’s potential for growth, competitive advantages, and strategic positioning within the market. The investment rationale section 104 provides the foundational arguments that support the investment thesis.

The market position section 106 details the company’s standing within the industry. This section includes information on market share, competitive landscape, and market trends that impact the company’s performance. The market position section 106 provides insights into how the company compares to peers and the overall market dynamics.

The financial overview section 108 is a comprehensive analysis of the company’s financial health. This section includes detailed financial statements, financial metrics, and performance indicators. The financial overview section 108 provides a thorough examination of the company’s revenue, profitability, cash flow, and other financial data.

The management team section 110 highlights the individuals leading the company. This section includes profiles of the executive team, their experience, and their roles within the organization. The management team section 110 provides insights into the leadership’s capability and track record.

The growth strategy section 112 outlines the company’s plans for future growth. This section includes strategic initiatives, expansion plans, and any significant projects or investments that the company is undertaking to drive growth. The growth strategy section 112 provides a forward-looking perspective on the company’s potential.

The risk analysis section 114 identifies and evaluates the potential risks associated with the investment. This section includes an assessment of market risks, operational risks, financial risks, and any other factors that could impact the company’s performance. The risk analysis section 114 provides a balanced view of the potential challenges and uncertainties.

The report 100 is structured to ensure that each section is clearly defined and organized, allowing for easy navigation and comprehension. The system described is capable of deconstructing example reports provided by the end-user and creating or processing a workflow to generate a custom report that emulates the content and structure of the example reports. This capability allows for the generation of tailored reports that meet specific user requirements and preferences, ensuring consistency and accuracy in financial reporting and analysis.

The process of generating an individual report, such as the investment memorandum report 100 depicted in FIG. 1, involves several steps. Initially, data acquisition is conducted to gather all relevant information from various sources, which may include financial databases, market reports, and internal company records. Following this, the information synthesis phase integrates and analyzes the data to extract meaningful insights pertinent to the report's objectives. Finally, the formatting step organizes this information into a structured document, ensuring that each section is clearly presented and logically flows from one to the next. This structured approach facilitates the reader's understanding and enhances the usability of the report.

In actual practice, the landscape of financial and strategic reports is vast, with hundreds, if not thousands, of different types of reports, each tailored to specific purposes and audiences. These reports vary significantly in terms of the nature of the content included and the overall formatting for presentation. For instance, a market analysis report will differ markedly from a risk assessment report or a corporate sustainability report, not only in the type of information presented but also in how it is structured and delivered to meet the specific needs of its intended audience.

Consistent with embodiments described herein, a new technique revolutionizes the creation of such reports by automating the generation of customized reports that emulate the content and structure of example reports provided by the user, with minimal human interaction. Utilizing one or more fine-tuned generative language models (e.g., LLMs) and one or more custom prompts, the system is capable of deconstructing the example reports to “understand” their format and key components. It then applies this understanding to generate new reports that maintain the consistency and accuracy required for effective financial analysis and decision-making. This innovative approach allows users to produce highly tailored reports efficiently, ensuring that they meet specific user requirements and preferences while maintaining a high standard of quality and relevance. Other aspects and advantages of the several embodiments will be readily apparent from the description of the several figures that follows.

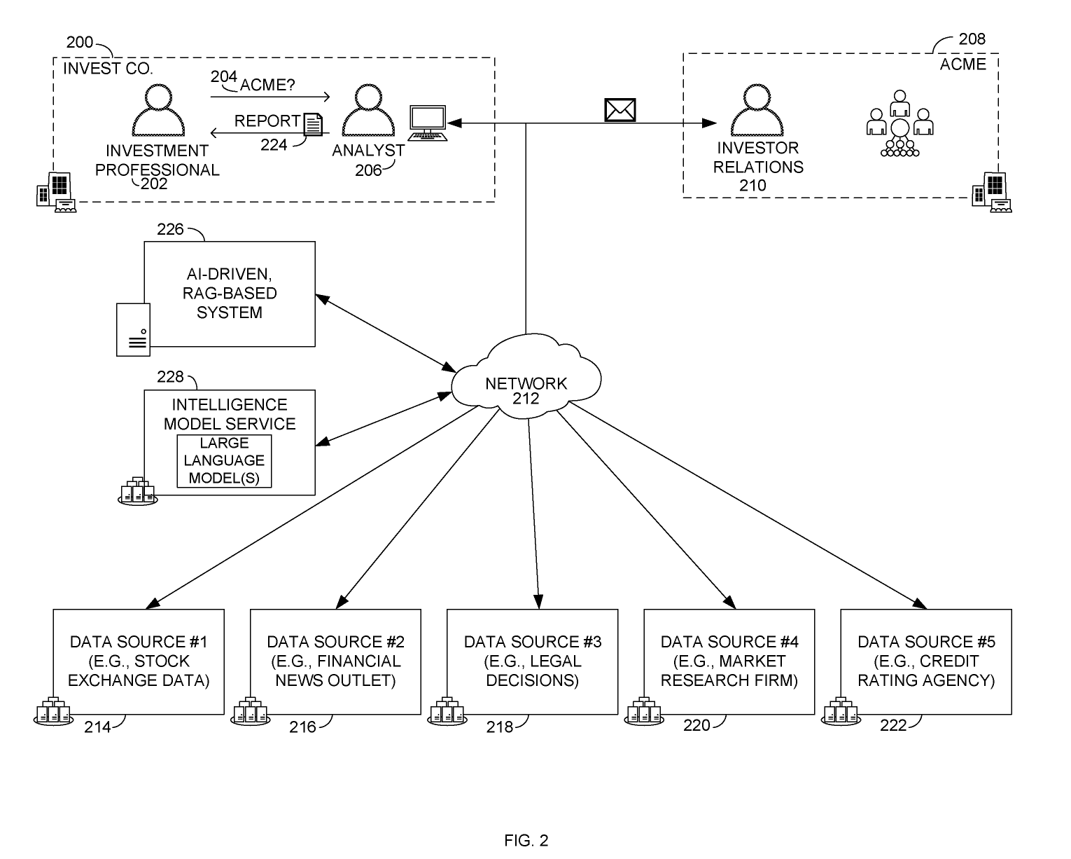

FIG. 2 illustrates an improved task-based, AI-driven, data retrieval and processing system for generating customized reports. The system comprises an AI-driven, RAG-based system 226 that is designed to leverage an integrated artificial intelligence model service 228, which hosts one or more generative language models (e.g., LLMs). The system 226 communicates and exchanges data over a network 212, and is configurated to obtain data from multiple data sources including, by way of example, data source #1 (e.g., stock exchange data 214), data source #2 (e.g., financial news outlet 216), data source #3 (e.g., legal decisions 218), data source #4 (e.g., market research firm 220), and data source #5 (e.g., credit rating agency 222).These data sources are presented here as examples, and in actual practice, there may be many more and varied data sources which are not depicted in FIG. 2.

An end-user, such as an analyst 206, utilizes a client computing device, which may include one or more client-based software applications (e.g., a web browser or proprietary software application) to access the system 226. The AI-driven, RAG-based system 226 connects to the network 212 to facilitate data retrieval and processing. The system 226 provides for the processing of a workflow, consisting of one or more complex tasks decomposed into manageable sub-tasks, executed via a processing pipeline to generate customized reports or outputs that align with specific user requirements and objectives. The system 226 leverages advanced techniques in machine learning, natural language processing, and data analytics. The system processes queries and workflows in the manner described in related U.S. Provisional Patent Applications 63/566,177 (“ ENHANCED QUERY PROCESSING USING DOMAIN SPECIFIC RETRIEVAL-AUGMENTED GENERATION FOR FINANCIAL SERVICES “) and ______ (“AI-DRIVEN, DYNAMIC, TASK-BASED INFORMATION RETRIEVAL AND PROCESSING SYSTEM”).

The intelligence model service 228, which includes one or more generative language models, enhances the RAG-based system 226 by providing advanced natural language processing capabilities of one or more fine-tuned LLMs. For example, an LLM of the intelligence model service 228 augments queries with domain-specific knowledge graphs, filters out irrelevant information through noise reduction algorithms, and dynamically ranks documents based on user context and intent.

An end-user, such as an analyst 206, utilizes a client computing device, which may include one or more client-based software applications (including, for example, a web browser or proprietary software application) to access the system 226. The intelligence model service 228 is a cloud-based provider of AI models, such as generative language models, including specifically what are known as Large Language Models (LLMs). LLMs are Transformer decoder-based models, some of which are known as Generative Pre-trained Transformers (GPTs). The service provides access to these models via an application programming interface (API). The system 226 may be integrated to use multiple models in parallel, where specific prompts associated with specific queries, associated with specific tasks, are routed to fine-tuned models best suited for the task at hand. Some models may be multi-modal, meaning they have vision capabilities and can process information beyond just text.

The intelligence model service 228, which includes large language models, enhances the RAG-based system 226 by providing advanced natural language processing capabilities. The intelligence model service 228 augments user queries with domain-specific knowledge graphs, filters out irrelevant information through noise reduction algorithms, and dynamically ranks documents based on user context and intent. This integration ensures that the system 226 can efficiently and accurately process complex tasks, providing end-users with high-quality, customized reports and outputs.

The network 212 facilitates communication between the AI-driven, RAG-based system 226, the intelligence model service 228, and the various data sources. The network 212 ensures seamless data transfer and integration, enabling the system 226 to access and process information from multiple sources efficiently.

Data source #1214 provides stock exchange data, which includes information related to stock prices, trading volumes, and market trends. Data source #2216 offers financial news, which includes updates on market developments, company announcements, and economic indicators. This information helps analysts stay informed about financial news and trends. Data source #3218 supplies legal decisions, which include court rulings, regulatory updates, and legal precedents. This data is necessary for understanding the legal landscape and assessing potential legal risks. Data source #4220 provides market research, which includes industry reports, competitor analysis, and market forecasts. This information helps analysts understand market dynamics and make informed investment decisions. Data source #5222 offers credit ratings, which include assessments of companies’ creditworthiness and financial stability. This data is important for evaluating credit risk and making investment decisions. It should be noted that these examples represent only a subset of the myriad data sources that may be available in actual practice, each contributing unique and valuable insights to enhance the comprehensiveness and accuracy of financial reporting and analysis.

The investment company 200 includes an investment professional 202 who identifies the need for a report and communicates this requirement to an analyst 206. The analyst 206 uses the AI-driven, RAG-based system 226 to gather and process data from the various data sources, generating a customized report. Consistent with some embodiments and as described in greater detail below, in some instances, the analyst 206 may be asked to generate a report that is not natively supported by an existing task and workflow of the system 226. In such an instance, the system 226 provides for the ability to provide as input to the system one or more existing reports. Additionally, the analyst may select a task or workflow that most closely aligns with the desired output, even when the task or workflow is known to generate an output different from what is desired.

Using the example reports as input and the selected task, the system 226 will leverage a fined-tuned generative language model to generate one or more custom queries. By way of example, the example reports may be provided as input (E.g., context) to an LLM, with an LLM prompt that instructs the LLM to analyze the example reports and generate some number of custom queries that could be executed against one or more data sources to obtain the type of information that is conveyed by the example reports. Accordingly, the LLM will generate as output some number of custom queries. These custom queries are then processed in the manner described in greater detail in the aforementioned US provisional patent applications, in order to generate for each query, a query result that can then be used as input (context) in a subsequent call or request to an LLM. For example, the query results from processing the custom queries may be provided as input to an LLM along with an LLM prompt that instructs the LLM to analyze the information (context) to generate a report that is similar to that conveyed by the example reports.

The output of the LLM, representing a first instance of the customized report may then be compared with one or more of the example reports, for example, with a view to determining whether there are any significant gaps – missing report components or insufficient information. This comparison may be performed using a generative language model, providing the first instance of the custom report and the example report as input (context), with an LLM prompt that instructs the model to analyze the reports and identify what elements are missing, or how the custom report could be improved. Using the output of this LLM request, a subsequent query can be generated, and the various steps can be iteratively performed until the final custom report converges to emulate the example reports.

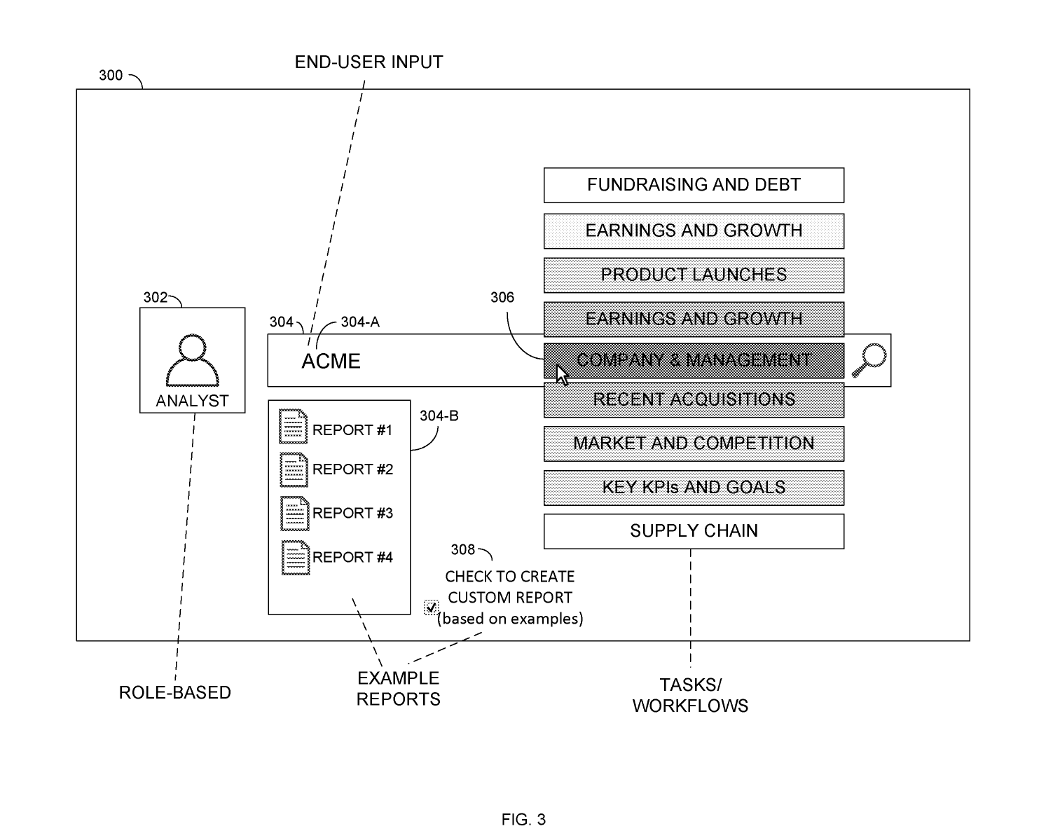

FIG. 3 shows an example user interface for the system. The interface 300 is designed to facilitate the generation of custom reports based on example reports provided by the end-user. The interface 300 includes several components that enable the user to input relevant data and select specific tasks or workflows for report generation.

The role-based input section 302 allows the user, identified as an analyst, to interact with the system. The user can input the company name 304, in this case, “ACME,” which serves as the primary entity for the report generation process. Adjacent to the company name input, the user can select, or specify (e.g., upload) a list of example reports 304-B. Here, an example report is an existing report that may have been created manually, or by another system. These example reports, labeled as Report #1, Report #2, Report #3, and Report #4, represent the type of report the user wishes to emulate in the new custom report. For example, each report may be relevant to a different company, whereas the end-user is now desiring to create a similar report, but for a new and different company – ACME.

The tasks/workflows section 306 provides a list of predefined tasks that the user can select to guide the report generation process. These tasks include options such as “Fundraising and Debt,” “Earnings and Growth,” “Product Launches,” “Company & Management,” “Recent Acquisitions,” “Market and Competition,” “KPIs and Goals,” and “Supply Chain.” In the illustrated example, the user has selected the “Company & Management” task, which is highlighted to indicate the active selection. In this instance, as the end-user is generating a custom report, the end-user may select a task or workflow that has an output that most closely aligns with the desired output (e.g., the custom report).

The interface 300 also includes a checkbox 308 labeled “Check to Create Custom Report (based on examples).” This option allows the user to instruct the system to generate a custom report that closely follows the format and content of the specified or pvodied example reports. By selecting this option, the user enables the system to analyze the example reports and create a new report that adheres to the desired structure and content specifications.

The end-user input section is designed to be intuitive and user-friendly, allowing the analyst to easily input the necessary information and select the appropriate tasks or workflows. The system leverages the provided example reports and the selected task to generate a custom report that meets the specific needs and preferences of the user, ensuring consistency and accuracy in financial reporting and analysis.

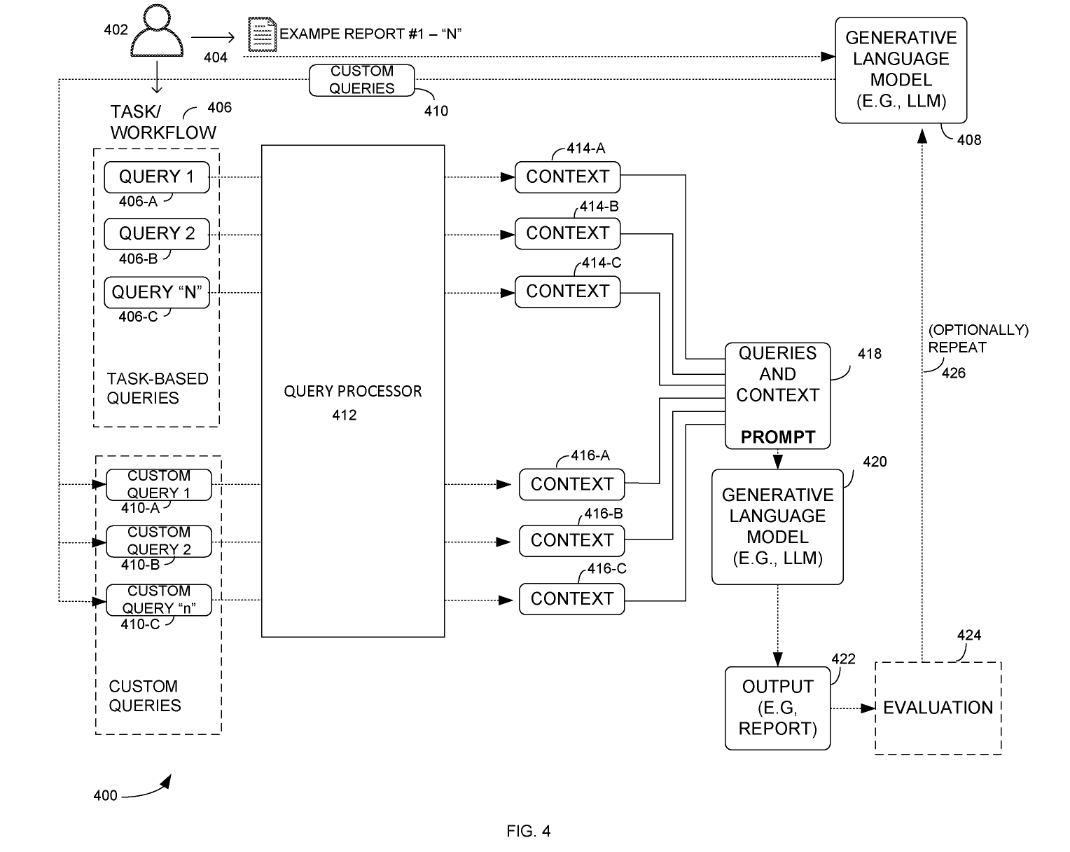

FIG. 4 shows a data processing technique for generating a custom report. An end user 402 specifies or provides several example reports 402-B. Additionally, the end user may select or specify a task 404 that is associated with an existing workflow 406, where the workflow is mapped to existing task-based queries 406-A, 406-B, and 406-C for selecting relevant information. The first step involves the use of a fine-tuned generative language model 408 to process a prompt that includes some instruction directing the model to analyze the example reports provided as context, for the purpose of generating custom queries 410. The example reports are provided to the generative language model as input (e.g., what is commonly referred to as the context), and the generative language model is asked, via an instruction or task expressed in an LLM prompt, to create a number of queries that could be used to select and obtain the information included in the example reports. The output of the generative language model is a set of custom queries 410-A, 410-B, and 410-C. The number of custom queries may differ from one example to the next, and each custom query may require some additional post-processing in order to prepare the query for execution against a particular data source.

The task-based queries, which associated with the selected workflow, and the custom queries, are processed by a query processor 412 to generate query results, shown in FIG. 4 as context 414-A, 414-B, and 414-C, for the task-based queries, and 416-A, 416-B, and 416-C, for the custom queries. The details of the query processing by the query processor 412 are not shown. In some embodiments, the query processor processes the queries as described in related US provisional patent application number _____. Generally, this involves augmenting user queries with domain-specific knowledge graphs, filtering out irrelevant information through noise reduction algorithms, and dynamically ranking documents based on user context and intent. The query processor refines the retrieval of information by employing advanced techniques to ensure that the output is not only relevant but also tailored to the specific needs of the workflow, enhancing the accuracy and utility of the generated context.

With the queries having been processed to establish the context – that is, the information from which the report will be synthesized – the next step involves using a prompt generator to generate a prompt 418, with an instruction for processing by the LLM 420, where instruction requests the LLM to process the context to generate the custom report in the style and format of the example reports. In some instances, some or all of the instruction that is included in the prompt will be the output from an LLM, having processed a previous prompt. The prompt is provided to the generative language model 420, which generates as output a custom report that emulates the example reports.

Consistent with some embodiments, the resulting output 422 from the generative language model may be once again provided as input to a generative language model with an instruction that the generative language model evaluate the custom report in combination with one or more of the example reports or a default report of the same type, for the purpose of identifying any potential content that is in an example report but not in the resulting output for the custom report. According to the output of the generative language model from this evaluation step 424 (optional), which may identify content missing from the custom report, can be included in yet another prompt to the generative language model, with an instruction to generate a query that will select the relevant content that is missing.

The query processing is then repeated, using context (query results) from the new queries that were output by the LLM at the evaluation step. Accordingly, the process shown in FIG. 4 is repeated, each time updating the final custom report with any additional missing information from the first instance of the custom report. This process can be repeated several times until there is a convergence such that the final output from the generative language model representing the custom report sufficiently emulates the example reports.

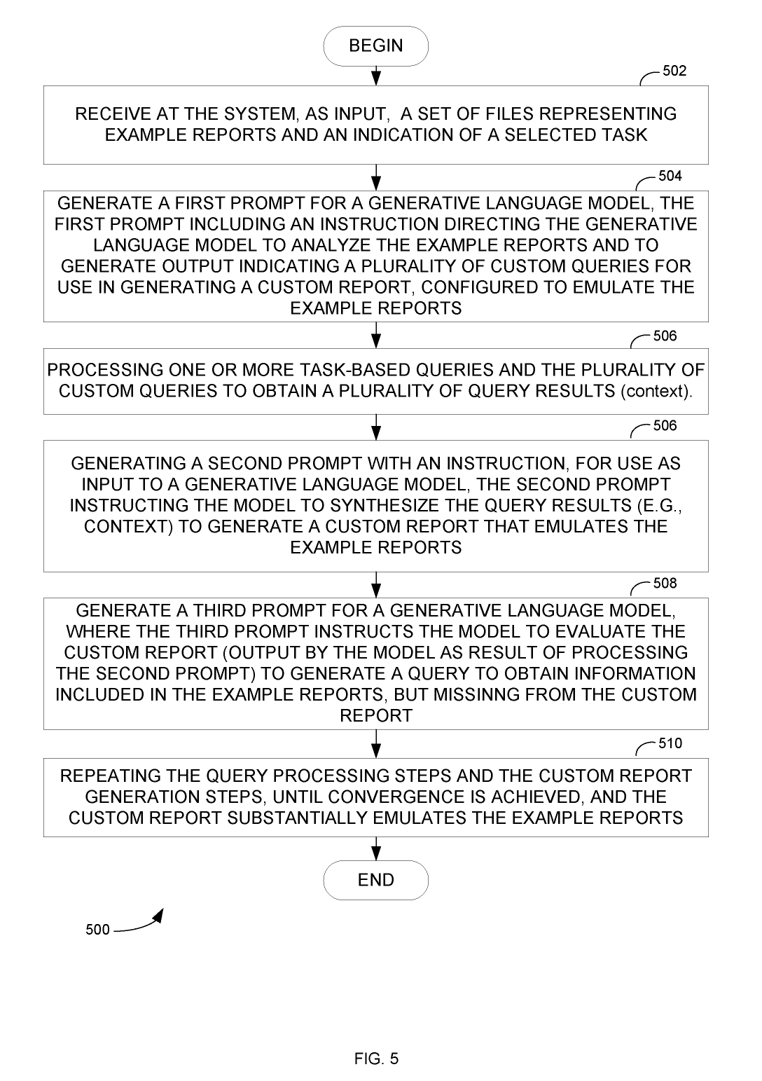

FIG. 5 shows a method as performed by the system or data processing pipeline illustrated in FIG. 4. The method involves several steps to generate a custom report that emulates example reports provided by the end-user.

In step 502, the system receives, as input, a set of files representing example reports and an indication of a selected task. These example reports serve as templates or guidelines for the type of report the user wishes to create, providing a clear model for the system to emulate.

In step 504, the system generates a first prompt for a generative language model. The first prompt includes an instruction directing the generative language model to analyze the example reports and to generate output indicating a plurality of custom queries for use in generating a custom report, configured to emulate the example reports. The large language model processes the example reports to understand the structure, sections, and types of information that are typically included, helping to identify the elements that are featured in the custom report.

In step 506, the system processes one or more task-based queries and the plurality of custom queries to obtain a plurality of query results (context). The task-based queries and the custom queries are processed by a query processor to generate context. The details of the query processing by the query processor are not shown. The output of the query processing is the query result, or context, for each query.

In step 506, the system generates a second prompt with an instruction, for use as input to a generative language model. The second prompt instructs the model to synthesize the query results (e.g., context) to generate a custom report that emulates the example reports. The large language model integrates and synthesizes the collected data according to the structure and format identified from the example reports, organizing the information into designated sections such as financial performance, market analysis, etc.

In step 508, the system generates a third prompt for a generative language model. The third prompt instructs the model to evaluate the custom report (output by the model as a result of processing the second prompt) to generate a query to obtain information included in the example reports but missing from the custom report. The system iteratively refines the report by reassessing the collected data, possibly fetching additional information, and adjusting the content to better match the example reports.

In step 510, the system repeats the query processing steps and the custom report generation steps until convergence is achieved, and the final custom report substantially emulates the example reports. This iterative process ensures that the final custom report closely aligns with the user’s specifications and the standards set by the example reports, providing a comprehensive and accurate representation of the desired content and format.

### MACHINE AND SOFTWARE ARCHITECTURE

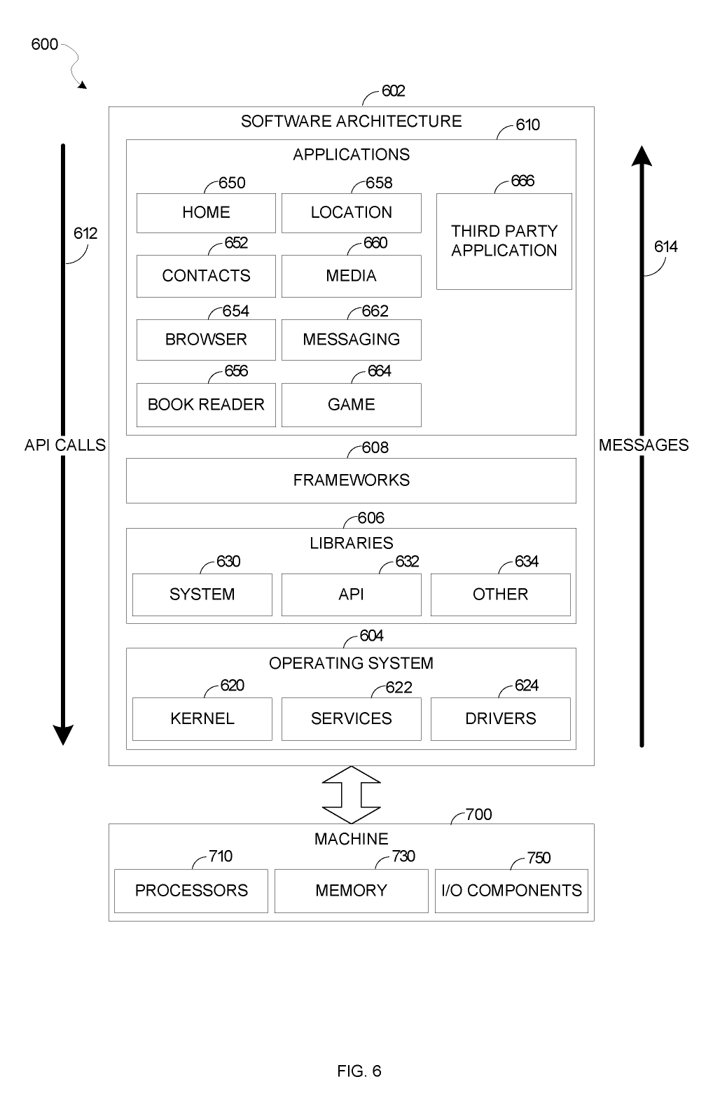

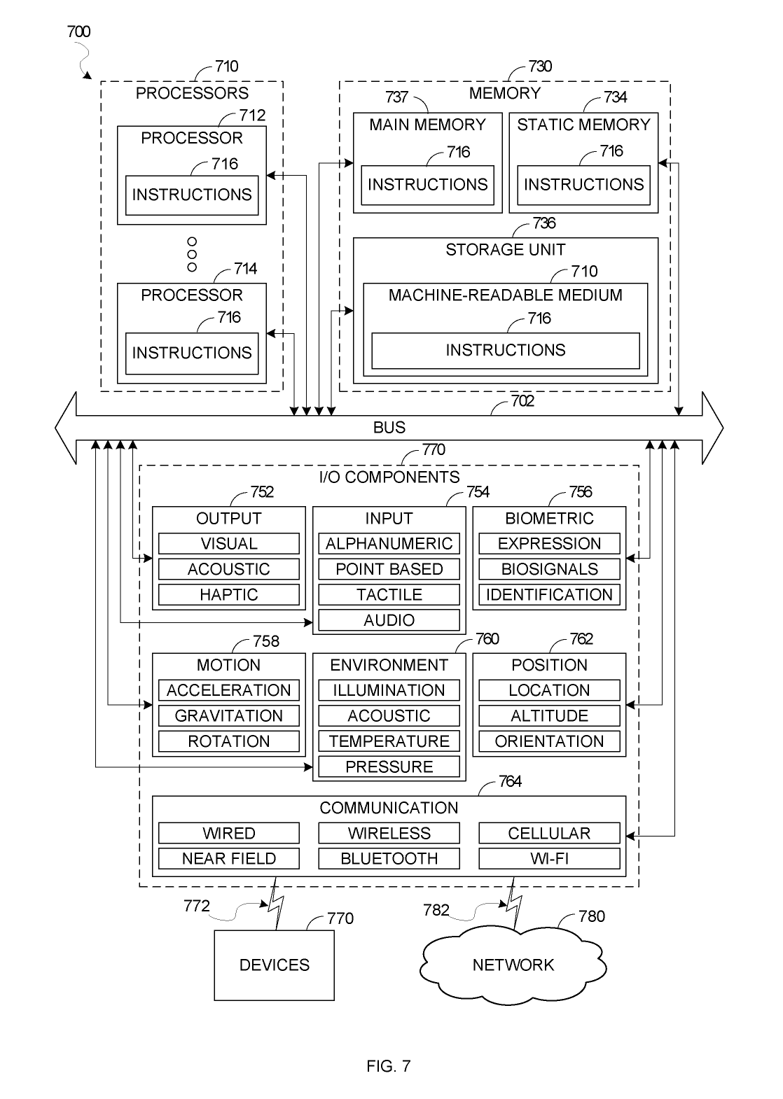

FIG. 6 is a block diagram 600 illustrating a software architecture 602, which can be installed on any of a variety of computing devices to perform methods consistent with those described herein. FIG. 6 is merely a non-limiting example of a software architecture, and it will be appreciated that many other architectures can be implemented to facilitate the functionality described herein. In various embodiments, the software architecture 602 is implemented by hardware such as a machine 700 of FIG. 7 that includes processors 710, memory 730, and input/output (I/O) components 750. In this example architecture, the software architecture 602 can be conceptualized as a stack of layers where each layer may provide a particular functionality. For example, the software architecture 602 includes layers such as an operating system 604, libraries 606, frameworks 608, and applications 610. Operationally, the applications 410 invoke API calls 412 through the software stack and receive messages 614 in response to the API calls 612, consistent with some embodiments.

In various implementations, the operating system 604 manages hardware resources and provides common services. The operating system 604 includes, for example, a kernel 620, services 622, and drivers 624. The kernel 620 acts as an abstraction layer between the hardware and the other software layers, consistent with some embodiments. For example, the kernel 620 provides memory management, processor management (e.g., scheduling), component management, networking, and security settings, among other functionality. The services 622 can provide other common services for the other software layers. The drivers 624 are responsible for controlling or interfacing with the underlying hardware, according to some embodiments. For instance, the drivers 624 can include display drivers, camera drivers, BLUETOOTH® or BLUETOOTH® Low Energy drivers, flash memory drivers, serial communication drivers (e.g., Universal Serial Bus (USB) drivers), Wi-Fi® drivers, audio drivers, power management drivers, and so forth.

In some embodiments, the libraries 606 provide a low-level common infrastructure utilized by the applications 610. The libraries 606 can include system libraries 630 (e.g., C standard library) that can provide functions such as memory allocation functions, string manipulation functions, mathematic functions, and the like. In addition, the libraries 606 can include API libraries 632 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic context on a display), database libraries (e.g., SQLite to provide various relational database functions), web libraries (e.g., WebKit to provide web browsing functionality), and the like. The libraries 606 can also include a wide variety of other libraries 634 to provide many other APIs to the applications 610.

The frameworks 608 provide a high-level common infrastructure that can be utilized by the applications 610, according to some embodiments. For example, the frameworks 608 provide various GUI functions, high-level resource management, high-level location services, and so forth. The frameworks 608 can provide a broad spectrum of other APIs that can be utilized by the applications 610, some of which may be specific to a particular operating system 604 or platform.

In an example embodiment, the applications 610 include a home application 650, a contacts application 652, a browser application 654, a book reader application 656, a location application 658, a media application 660, a messaging application 662, a game application 664, and a broad assortment of other applications, such as a third-party application 666. According to some embodiments, the applications 610 are programs that execute functions defined in the programs. Various programming languages can be employed to create one or more of the applications 510, structured in a variety of manners, such as object-oriented programming languages (e.g., Objective-C, Java, or C++) or procedural programming languages (e.g., C or assembly language). In a specific example, the third-party application 666 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 666 can invoke the API calls 612 provided by the operating system 604 to facilitate functionality described herein.

FIG. 7 illustrates a diagrammatic representation of a machine 600 in the form of a computer system within which a set of instructions may be executed for causing the machine to perform any one or more of the methodologies discussed herein, according to an example embodiment. Specifically, FIG. 7 shows a diagrammatic representation of the machine 700 in the example form of a computer system, within which instructions 716 (e.g., software, a program, an application, an applet, an app, or other executable code) for causing the machine 700 to perform any one or more of the methodologies discussed herein may be executed. For example the instructions 716 may cause the machine 700 to execute any one of the methods or algorithmic techniques described herein. Additionally, or alternatively, the instructions 716 may implement any one of the systems described herein. The instructions 716 transform the general, non-programmed machine 700 into a particular machine 700 programmed to carry out the described and illustrated functions in the manner described. In alternative embodiments, the machine 700 operates as a standalone device or may be coupled (e.g., networked) to other machines. In a networked deployment, the machine 700 may operate in the capacity of a server machine or a client machine in a server-client network environment, or as a peer machine in a peer-to-peer (or distributed) network environment. The machine 700 may comprise, but not be limited to, a server computer, a client computer, a PC, a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 716, sequentially or otherwise, that specify actions to be taken by the machine 700. Further, while only a single machine 700 is illustrated, the term “machine” shall also be taken to include a collection of machines 700 that individually or jointly execute the instructions 616 to perform any one or more of the methodologies discussed herein.

The machine 700 may include processors 710, memory 730, and I/O components 750, which may be configured to communicate with each other such as via a bus 702. In an example embodiment, the processors 710 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 712 and a processor 714 that may execute the instructions 716. The term “processor” is intended to include multi-core processors that may comprise two or more independent processors (sometimes referred to as “cores”) that may execute instructions contemporaneously. Although FIG. 7 shows multiple processors 710, the machine 700 may include a single processor with a single core, a single processor with multiple cores (e.g., a multi-core processor), multiple processors with a single core, multiple processors with multiples cores, or any combination thereof.

The memory 730 may include a main memory 732, a static memory 734, and a storage unit 736, all accessible to the processors 710 such as via the bus 702. The main memory 730, the static memory 734, and storage unit 736 store the instructions 716 embodying any one or more of the methodologies or functions described herein. The instructions 716 may also reside, completely or partially, within the main memory 732, within the static memory 734, within the storage unit 736, within at least one of the processors 710 (e.g., within the processor’s cache memory), or any suitable combination thereof, during execution thereof by the machine 700.

The I/O components 750 may include a wide variety of components to receive input, provide output, produce output, transmit information, exchange information, capture measurements, and so on. The specific I/O components 750 that are included in a particular machine will depend on the type of machine. For example, portable machines such as mobile phones will likely include a touch input device or other such input mechanisms, while a headless server machine will likely not include such a touch input device. It will be appreciated that the I/O components 750 may include many other components that are not shown in FIG. 7. The I/O components 750 are grouped according to functionality merely for simplifying the following discussion and the grouping is in no way limiting. In various example embodiments, the I/O components 750 may include output components 752 and input components 754. The output components 752 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 754 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 750 may include biometric components 756, motion components 758, environmental components 760, or position components 762, among a wide array of other components. For example, the biometric components 756 may include components to detect expressions (e.g., hand expressions, facial expressions, vocal expressions, body gestures, or eye tracking), measure bio-signals (e.g., blood pressure, heart rate, body temperature, perspiration, or brain waves), identify a person (e.g., voice identification, retinal identification, facial identification, fingerprint identification, or electroencephalogram-based identification), and the like. The motion components 758 may include acceleration sensor components (e.g., accelerometer), gravitation sensor components, rotation sensor components (e.g., gyroscope), and so forth. The environmental components 660 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 662 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 750 may include communication components 764 operable to couple the machine 700 to a network 780 or devices 770 via a coupling 782 and a coupling 772, respectively. For example, the communication components 764 may include a network interface component or another suitable device to interface with the network 780. In further examples, the communication components 764 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 770 may be another machine or any of a wide variety of peripheral devices (e.g., a peripheral device coupled via a USB).

Moreover, the communication components 764 may detect identifiers or include components operable to detect identifiers. For example, the communication components 764 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 764, such as location via Internet Protocol (IP) geolocation, location via Wi-Fi® signal triangulation, location via detecting an NFC beacon signal that may indicate a particular location, and so forth.

### EXECUTABLE INSTRUCTIONS AND MACHINE STORAGE MEDIUM

The various memories (i.e., 730, 732, 734, and/or memory of the processor(s) 710) and/or storage unit 736 may store one or more sets of instructions and data structures (e.g., software) embodying or utilized by any one or more of the methodologies or functions described herein. These instructions (e.g., the instructions 716), when executed by processor(s) 610, cause various operations to implement the disclosed embodiments.

As used herein, the terms “machine-storage medium,” “device-storage medium,” “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

### TRANSMISSION MEDIUM

In various example embodiments, one or more portions of the network 780 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 780 or a portion of the network 780 may include a wireless or cellular network, and the coupling 782 may be a Code Division Multiple Access (CDMA) connection, a Global System for Mobile communications (GSM) connection, or another type of cellular or wireless coupling. In this example, the coupling 782 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 716 may be transmitted or received over the network 780 using a transmission medium via a network interface device (e.g., a network interface component included in the communication components 764) and utilizing any one of a number of well-known transfer protocols (e.g., HTTP). Similarly, the instructions 716 may be transmitted or received using a transmission medium via the coupling 772 (e.g., a peer-to-peer coupling) to the devices 770. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 716 for execution by the machine 700, and includes digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a matter as to encode information in the signal.

### COMPUTER-READABLE MEDIUM

The terms “machine-readable medium,” “computer-readable medium” and “device-readable medium” are intended to mean the same thing and may be used interchangeably in this disclosure. The terms are defined to include both machine-storage media and transmission media. Thus, the terms include both storage devices/media and carrier waves/modulated data signals.

What is claimed is:

1. A computer-implemented method for generating a custom financial report based on one or more example financial reports, the method comprising:
receiving, as input to a computing system, a set of example financial reports and a selected task;
generating a first prompt instructing a generative language model to analyze the example financial reports and generate a plurality of custom queries configured to retrieve information of a type contained in the one or more example financial reports;
processing the plurality of custom queries through a query processing pipeline to obtain query results from one or more data sources;
generating a second prompt instructing the generative language model to synthesize the query results to generate a draft custom report that emulates the one or more example financial reports;
evaluating the draft custom report against the one or more example financial reports to identify missing information and generate additional queries to obtain the missing information;
iteratively repeating the query processing and report generation steps using the additional queries until the custom report substantially replicates the structure and content organization of the one or more example financial reports; and
outputting the custom report in a format that maintains the structure and content organization of the example financial reports.

2. The method of claim 1, wherein the selected task corresponds to a predefined workflow comprising a plurality of task-based queries, and wherein processing the plurality of custom queries further comprises processing the task-based queries to obtain additional query results that are combined with the custom query results when generating the draft custom report.

3. The method of claim 1, wherein the query processing pipeline comprises:
augmenting each custom query with domain-specific knowledge; retrieving relevant documents from the one or more data sources; filtering the retrieved documents to remove irrelevant information; and ranking the filtered documents based on relevance to the custom query.

4. The method of claim 1, wherein evaluating the draft custom report comprises:
generating a third prompt instructing the generative language model to compare the draft custom report with the example financial reports; identifying content gaps where information present in the example financial reports is missing from the draft custom report; and
automatically generating the additional queries based on the identified content gaps.

5. The method of claim 1, wherein the example financial reports comprise reports having different structural formats, and wherein the first prompt further instructs the generative language model to: identify common structural elements across the example financial reports; and determine content types and presentation formats used in the example financial reports to guide generation of the custom queries.

6. The method of claim 1, wherein the iterative repeating step comprises:
determining a convergence metric by comparing the custom report with the example financial reports; and
continuing the iterative process when the convergence metric indicates insufficient similarity; and terminating the iterative process when the convergence metric exceeds a predetermined threshold indicating substantial replication of the example financial reports.

7. The method of claim 1, further comprising: receiving user selection of a role-based workflow from a plurality of available workflows, wherein each workflow is associated with different types of financial analysis tasks; and customizing the query processing pipeline based on the selected role-based workflow to apply role-specific filtering rules and data source prioritization.

8. A system for generating a custom financial report that has a format based on one or more example financial reports, the system comprising:
one or more processors; and
one or more memory storage devices storing instructions thereon, which, when executed by the one or more processors, cause the system to perform operations comprising:
receiving, as input to a computing system, a set of example financial reports and a selected task;
generating a first prompt instructing a generative language model to analyze the example financial reports and generate a plurality of custom queries configured to retrieve information of a type contained in the example financial reports;
processing the plurality of custom queries through a query processing pipeline to obtain query results from one or more data sources;
generating a second prompt instructing the generative language model to synthesize the query results to generate a draft custom report that emulates the example financial reports;
evaluating the draft custom report against the example financial reports to identify missing information and generate additional queries to obtain the missing information;
iteratively repeating the query processing and report generation steps using the additional queries until the custom report substantially replicates the example financial reports; and
outputting the custom report in a format that maintains the structure and content organization of the example financial reports.

9. The system of claim 8, wherein the selected task corresponds to a predefined workflow comprising a plurality of task-based queries, and wherein processing the plurality of custom queries further comprises processing the task-based queries to obtain additional query results that are combined with the custom query results when generating the draft custom report.

10. The system of claim 8, wherein the query processing pipeline comprises:
augmenting each custom query with domain-specific knowledge; retrieving relevant documents from the one or more data sources; filtering the retrieved documents to remove irrelevant information; and ranking the filtered documents based on relevance to the custom query.

11. The system of claim 8, wherein evaluating the draft custom report comprises:
generating a third prompt instructing the generative language model to compare the draft custom report with the example financial reports; identifying content gaps where information present in the example financial reports is missing from the draft custom report; and
automatically generating the additional queries based on the identified content gaps.

12. The system of claim 8, wherein the example financial reports comprise reports having different structural formats, and wherein the first prompt further instructs the generative language model to: identify common structural elements across the example financial reports; and determine content types and presentation formats used in the example financial reports to guide generation of the custom queries.

13. The system of claim 8, wherein the iterative repeating step comprises:
determining a convergence metric by comparing the custom report with the example financial reports;
continuing the iterative process when the convergence metric indicates insufficient similarity; and
terminating the iterative process when the convergence metric exceeds a predetermined threshold indicating substantial replication of the example financial reports.

14. The system of claim 8, further comprising: receiving user selection of a role-based workflow from a plurality of available workflows, wherein each workflow is associated with different types of financial analysis tasks; and customizing the query processing pipeline based on the selected role-based workflow to apply role-specific filtering rules and data source prioritization.

15. A computer-implemented method for generating a custom financial report that replicates a format and content structure of a set of example financial reports, the method comprising:
receiving, as input to a computing system, a set of example financial reports and a selected task associated with a predefined workflow;
generating a first prompt for a generative language model, the first prompt including an instruction directing the generative language model to analyze the set of example financial reports to identify content structure and formatting characteristics, and to generate a plurality of custom queries configured to retrieve information of a type contained in the set of example financial reports;
processing the plurality of custom queries generated by the generative language model through a query processing pipeline to obtain a plurality of query results, wherein the query processing pipeline includes augmenting each custom query with domain-specific knowledge graph information, retrieving relevant documents from one or more data sources, filtering the retrieved documents to remove irrelevant information, and reranking the filtered documents based on relevance to the custom query;
generating a second prompt for the generative language model, the second prompt including an instruction to synthesize the plurality of query results to generate a draft custom report that emulates the format and content structure of the example financial reports;
generating a third prompt for the generative language model, the third prompt including an instruction to evaluate the draft custom report against the example financial reports to identify missing information and generate one or more additional queries to obtain the missing information;
iteratively repeating the query processing and report generation steps using the one or more additional queries until the custom report substantially replicates the format and content structure of the example financial reports; and
outputting the custom report in a structured format that maintains the specific formatting and content organization of the example financial reports.

16. The method of claim 15, wherein the predefined workflow comprises a plurality of task-based queries associated with the selected task, and wherein processing the plurality of custom queries further comprises: processing the plurality of task-based queries through the query processing pipeline to obtain task-based query results; and combining the task-based query results with the query results from the custom queries when generating the second prompt for synthesizing the draft custom report.

17. The method of claim 15, wherein the domain-specific knowledge graph information comprises financial entity relationships, industry classifications, and regulatory frameworks, and wherein augmenting each custom query comprises:
identifying financial entities and concepts within the custom query;
retrieving related entities and contextual information from the domain-specific knowledge graph; and
expanding the custom query to include the related entities and contextual information.

18. The method of claim 15, wherein filtering the retrieved documents to remove irrelevant information comprises:
applying machine learning-based noise reduction algorithms to identify and remove documents that do not match the content requirements of the selected task;
scoring each document based on relevance to the custom query and the selected task; and
retaining only documents that exceed a predetermined relevance threshold.

19. The method of claim 15, wherein the example financial reports comprise a plurality of reports having different formatting styles and content organizations, and wherein the first prompt further instructs the generative language model to:
identify common structural elements across the plurality of example financial reports;
determine section headings, content types, and presentation formats used in the example financial reports; and
generate the plurality of custom queries to retrieve information suitable for populating each identified structural element.

20. The method of claim 15, wherein the iterative repeating step comprises:
processing the one or more additional queries through the query processing pipeline to obtain additional query results;
generating a fourth prompt for the generative language model to synthesize the additional query results with previously obtained query results to generate an updated custom report;
comparing the updated custom report with the example financial reports to determine a convergence metric; and
terminating the iterative process when the convergence metric indicates that the updated custom report substantially matches the format and content structure of the example financial reports within a predetermined threshold.

21. The method of claim 15, wherein the one or more data sources comprise at least two of:
stock exchange data feeds, financial news outlets, legal decision databases, market research repositories, credit rating agency databases, regulatory filing systems, and company financial statements;
wherein the query processing pipeline is configured to:
route different custom queries to different data sources based on the type of information required; and
aggregate results from multiple data sources for individual custom queries when comprehensive information is needed.
